(19) United States
(12) Patent Application Publication
(10) Pub. No.: US 2012/0265918 A1
(43) Pub. Date: Oct. 18, 2012

(54) INTERFACE DEVICE AND WIRING BOARD

(75) Inventors: Tomoki Nakajima, Osaka (JP); Masayuki Jono, Osaka (JP)

(73) Assignee: SHARP KABUSHIKI KAISHA, Osaka (JP)

(21) Appl. No.: 13/443,376

(22) Filed: Apr. 10, 2012

(30) Foreign Application Priority Data
Apr. 15, 2011 (JP) 2011-090658

(51) Int. Cl. G06F 13/42

(52) U.S. Cl. 710/316

(57) ABSTRACT

In the case of mounting two serial communication interfaces such as PCI-e and USB 3.0 with standards different from each other, it is allowed to flexibly address a design change and the like, and reduce a board area. An interface device includes a PCI-e I/F, a USB 3.0 I/F with characteristic impedance and an electric characteristic which are equivalent to those of the PCI-e I/F, and a controller provided with the PCI-e I/F and the USB 3.0 I/F. The interface device is provided with a PHY bus switch for selectively switching between the PCI-e I/F and the USB 3.0 I/F, and in which wiring for connecting the PCI-e I/F and the PHY bus switch and wiring for connecting the USB 3.0 I/F and the PHY bus switch are shared therebetween.

### CROSS-NOTING PARAGRAPH

This non-provisional application claims priority under 35 U.S.C. §119(a) on Patent Application No. 2011-090658 filed in JAPAN on Apr. 15, 2011, the entire contents of which are hereby incorporated herein by reference.

### FIELD OF THE INVENTION

The present invention relates to an interface device and a wiring board, and more specifically, to an interface device of PCI-Express, USB 3.0 and the like allowing high-speed serial transfer, and a wiring board having the device mounted thereon.

### BACKGROUND OF THE INVENTION

Recently, in a field of an information processing apparatus including personal computers (PCs), an interface device employing a high-speed serial transmission system has been commercialized such as PCI-Express (Peripheral Component Interconnect Express, hereinafter referred to as PCI-e), USB (Universal Serial Bus) 3.0. This PCI-e employs, not a conventional parallel transmission system, but a serial transmission system, in which one serial communication wire of the PCI-e is referred to as a lane, and uses a plurality of lanes as appropriate to seek to increase the speed. In PCI-e Gen 2, data transfer speed of 5 Gbps at a maximum has been realized.

Further, USB 3.0 was developed based on the technology of the PCI-e Gen 2 described above, in which data transfer speed of 5 Gbs at a maximum is realized relative to 480 Mbs at a maximum of the USB 2.0 as a previous version thereof, seeking to significantly increasing the speed. In the USB 2.0, one differential transmission path is switched to be used on both an upstream direction and a downstream direction, however, in the USB 3.0, a dedicated differential transmission path is used for each of the upstream direction and the downstream direction to allow communication in both directions to be performed at the same time. This technology is a general method in high-speed serial communication of the PCI-e and the like.

Some common technologies have been employed in the USB 3.0 and the PCI-e, and for example, as a technology for increasing the speed, technologies of LVDS (Low Voltage Differential Signaling), CRU (Clock Recovery Unit) and the like have been employed. The LVDS is a differential signal transmission system using two transmission paths, and a system for converting a parallel signal into a low-voltage differential serial signal to be transmitted. In the USB 3.0, differential signal amplitude is defined to be at 0.8 V at a minimum, and 1.2 Vat a maximum as with the PCI-e. Additionally, regarding CRU, in the USB 3.0, an embedded clock system is employed in which a clock is embedded in a data signal as with the PCI-e. All of such technologies are defined in accordance with standards.

The above-described USBs have been widely used as a universal interface for connecting a PC with peripheral devices, however, most of PCs have included the USB 2.0 as standard equipment so far, and also the USB 3.0 is expected to be widely used from now. Further, there is a PC including the PCI-e as standard equipment other than the USB, and for example, a technology is described in Japanese Laid-Open Patent Publication No. 2009-9564 for sharing a connector for the PCI-e and a connector for the USB 2.0 between each other. This makes it possible to share one connecter between the PCI-e and the USB 2.0 having standards different from each other, thereby selectively connecting a PCI-e-compliant external device and a USB 2.0-compliant external device.

Here, the PCI-e and the USB 3.0 perform high-speed data transfer, which data signal is thus likely to be influenced by noise, in which strict restrictions are set to wiring of a board. Therefore, when these two interfaces are attempted to be mounted on an information processing apparatus such as a PC, it needs to arrange wiring of two systems in total, each of which is arranged for the PCI-e and the USB 3.0, further, both the two systems are subjected to the restrictions of wiring, so that the board area becomes large, which poses a problem.

One of the restrictions is characteristic impedance (also referred to as differential impedance), and according to the standards, the differential impedance of the PCI-e is defined as 100Ω±10% including a manufacturing error. For the differential impedance of USB 3.0, equivalent to that of the PCI-e, which is 90Ω±70Ω is defined. Furthermore, the above restrictions include an electric characteristic such as operating voltage, and equivalent electric characteristics are defined in the PCI-e and the USB 3.0.

In the case of mounting the PCI-e and the USB 3.0, it is required to determine a layer configuration in board wiring, a pattern width, a pattern interval and the like so as to satisfy conditions of the characteristic impedance. This also means that when having equivalent characteristic impedance, the board wiring is able to be arranged to be the same. That is, it is expected that when the conditions of the characteristic impedance are satisfied, the wiring for the PCI-e and the wiring for the USB 3.0 are able to be shared therebetween, so that the board area is able to be reduced.

Furthermore, in the case of assuming that a product is equipped with either the PCI-e or the USB 3.0, once wiring of the PCI-e is performed, it is naturally impossible to use the USB 3.0. Therefore, in the event of a design change afterwards to change to wiring of the USB 3.0, the wiring has to be changed. Even in this case, it is expected that the wiring for the PCI-e and the wiring for the USB 3.0 are shared therebetween to allow any one of the interfaces to be selected so that it is possible to flexibly address the design change afterwards.

However, since no technological thought has been proposed that the wiring for the PCI-e and the wiring for the USB 3.0 are shared therebetween in conventional technologies so far, it is impossible to solve the problem as described above. Further, the technology described in the Japanese Laid-Open Patent Publication No. 2009-9564 described above only indicated that the connector for the PCI-e and the connector for the USB 2.0 are shared therebetween, which does not refer to sharing of the wiring for the PCI-e and the wiring for the USB 3.0 therebetween.

### SUMMARY OF THE INVENTION

An object of the present invention is to provide an interface device capable of flexibly addressing a design change and the like in the case of mounting two serial communication interfaces such as PCI-e and USB 3.0 with standards different from each other, and reducing a board area, and a wiring board having the device mounted thereon.

An object of the present invention is to provide an interface device comprising: a first serial communication interface; a second serial communication interface with characteristic impedance and an electric characteristic which are equivalent to those of the first serial communication interface; and a controller provided with the first serial communication interface and the second serial communication interface, wherein a switching portion is provided for selectively switching between the first serial communication interface and the second serial communication interface, and wiring for connecting the first serial communication interface and the switching portion and wiring for connecting the second serial communication interface and the switching portion are shared therebetween.

Another object of the present invention is to provide the interface device, wherein the switching portion includes a first device side connecting portion for connecting a first device corresponding to the first serial communication interface; a second device side connecting portion for connecting a second device corresponding to the second serial communication interface; and a controller side connecting portion for connecting the first serial communication interface and the second serial communication interface via the shared wiring; and in the case of switching to the first serial communication interface, the first device side connecting portion and the controller side connecting portion are connected, and in the case of switching to the second serial communication interface, the second device side connecting portion and the controller side connecting portion are connected.

Another object of the present invention is to provide the interface device, wherein the controller includes a switching signal output portion to output a switching signal for switching between the first serial communication interface and the second serial communication interface, and the switching portion switches between the first serial communication interface and the second serial communication interface based on the switching signal output from the switching signal output portion.

Another object of the present invention is to provide the interface device, wherein the first serial communication interface is a PCI-Express system interface, and the second serial communication interface is a USB 3.0 system interface.

Another object of the present invention is to provide a wiring board having the interface device mounted thereon.

### BRIEF DESCRIPTION OF THE DRAWINGS

FIG. 1 is a block diagram showing a configuration example of an information processing apparatus provided with an interface device according to the present invention;

FIG. 2 is a block diagram showing a state where a PCI-e interface is selected in the interface device; and

FIG. 3 is a block diagram showing a state where a USB 3.0 interface is selected in the interface device.

### PREFERRED EMBODIMENTS OF THE INVENTION

Hereinafter, description will be given for preferred embodiments according to an interface device and a wiring board the device mounted thereon in the present invention with reference to accompanying drawings.

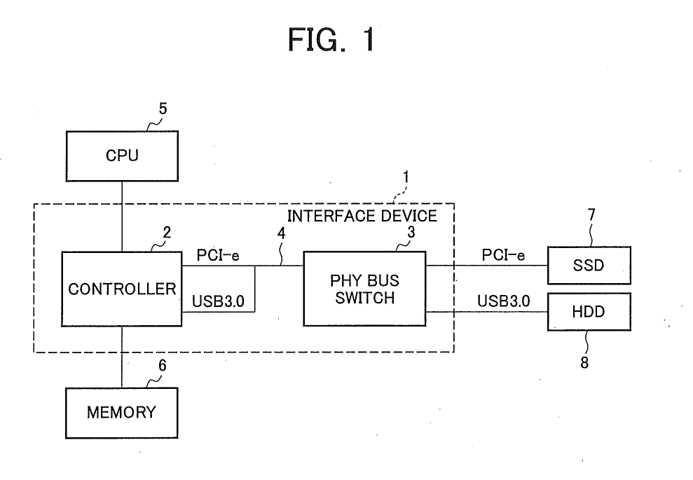

FIG. 1 is a block diagram showing a configuration example of an information processing apparatus provided with an interface device according to the present invention. This information processing apparatus is a general PC or the like including an interface device 1, a CPU 5, a memory 6, an SSD (Solid State Drive) 7, and an HDD (Hard Disk Drive) 8. The interface device 1 is comprised of a controller 2, a PHY bus switch 3, and shared wiring 4. To the controller 2, the CPU 5 and the memory 6 are connected, to the controller 2, the CPU 5 and the memory 6 are connected, and to the PHY bus switch 3, the SSD 7 and the HDD 8 are connected. The SSD 7 is an example of a PCI-e-compliant device and the HDD 8 is an example of a USB 3.0-compliant device.

The shared wiring 4 is provided for sharing the wiring for the PCI-e interface and the wiring for the USB 3.0 interface therebetween provided in the controller 2, and the controller 2 and the PHY bus switch 3 are connected to each other via the shared wiring 4. Note that, the “PHY” of the PHY bus switch 3 means a “physical layer”.

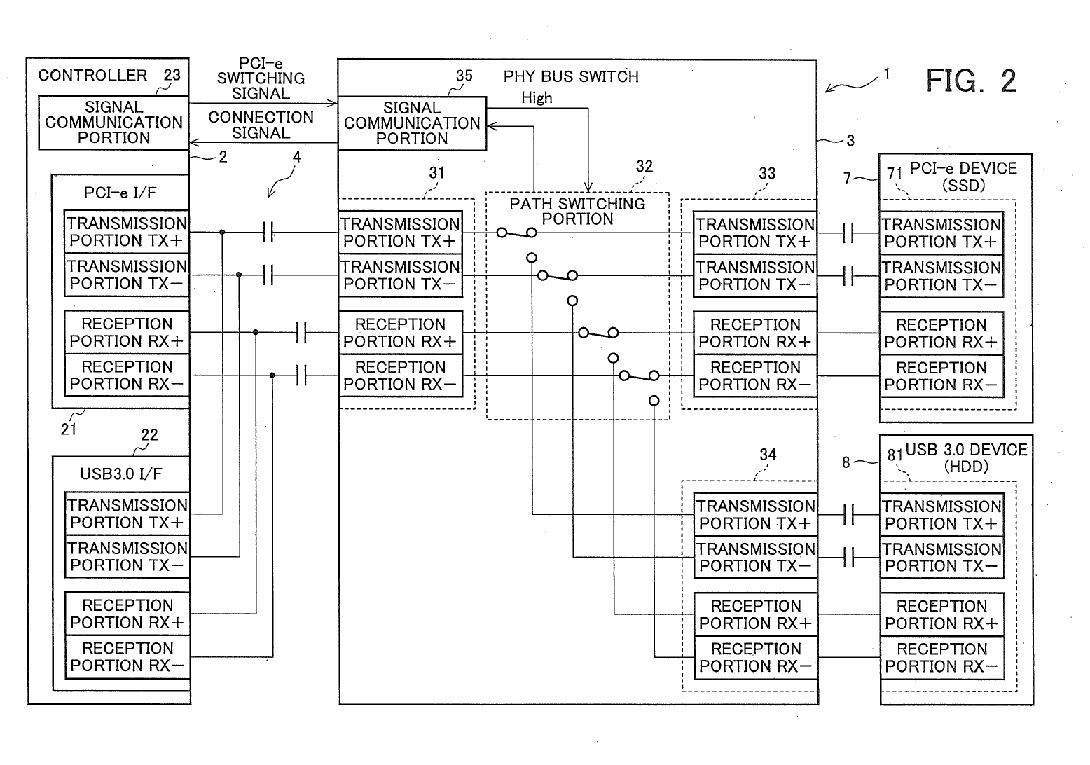

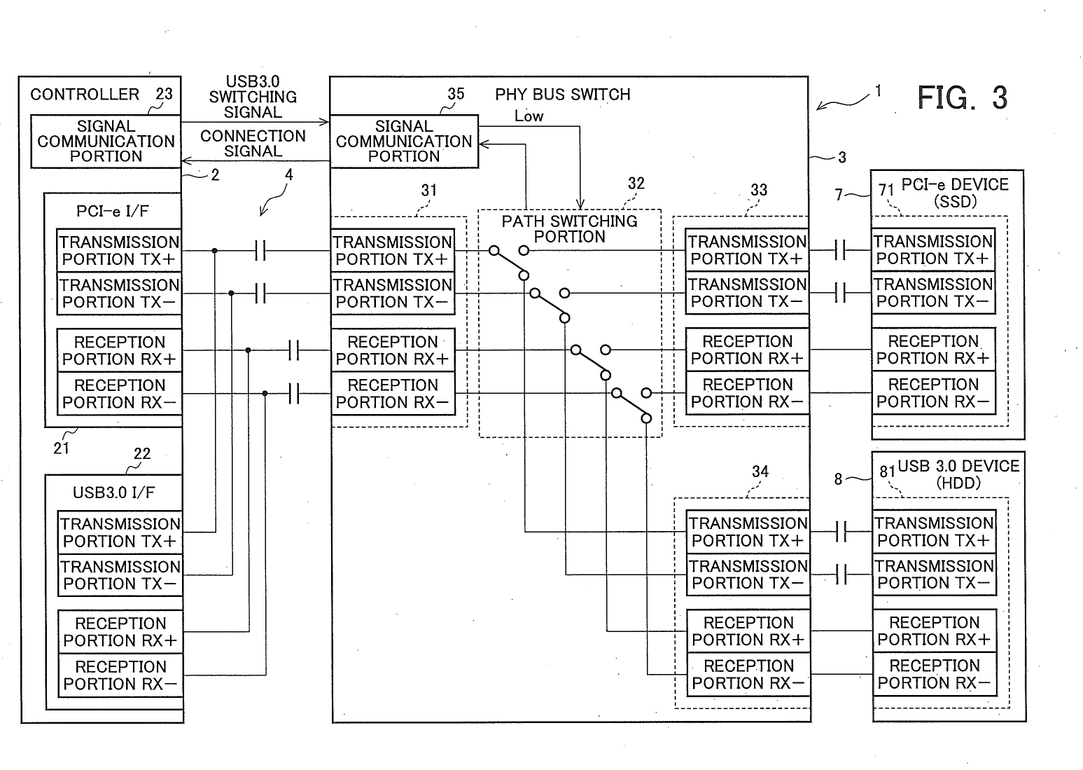

FIG. 2 and FIG. 3 are block diagrams showing specific configuration examples of the interface device 1 shown in FIG. 1. FIG. 2 shows a state where a PCI-e interface is selected, and FIG. 3 shows a state where a USB 3.0 interface is selected.

The controller 2 includes a PCI-e interface (hereinafter, PCI-e I/F) 21, a USB 3.0 interface (hereinafter, USB 3.0 I/F) 22 with characteristic impedance and an electric characteristic which is equivalent to that of the PCI-e I/F 21, and a signal communication portion 23. The PCI-e I/F 21 is an example of a first serial communication I/F of the present invention, and the USB 3.0 I/F 22 is an example of a second serial communication I/F of the present invention. Note that, as long as the characteristic impedance (differential impedance) and the electric characteristic are equivalent, the PCI-e I/F 21, a serial communication I/F other than the USB 3.0 is able to be applied.

The PCI-e I/F 21 is provided with a differential transmission portion (hereinafter, referred to as transmission portion TX+, TX−) and a differential reception portion (hereinafter, referred to as reception portion RX+, RX−). Similarly, the USB 3.0 I/F 22 is provided with a differential transmission portion (hereinafter, referred to as transmission portion TX+, TX−) and a differential reception portion (hereinafter, referred to as reception portion RX+, RX−). These PCI-e I/F 21 and USB 3.0 I/F 22 have the characteristic impedance and the electric characteristic equivalent to each other so as to be able to share the board wiring. The characteristic impedance is defined, as described above, according to the standard as 100Ω±10% for the PCI-e, and 90Ω+7Ω for the USB 3.0.

As shown in FIGS. 2 and 3, wiring for connecting the PCI-e I/F 21 and the PHY bus switch 3 and wiring for connecting the USB 3.0 I/F 22 and the PHY bus switch 3 are shared therebetween as the shared wiring 4. It is considered that the shared wiring 4 is shared by a method such as forming multiple layers (forming two layers) having an insulating layer therebetween, using a back side of the board, or the like.

The PHY bus switch 3 corresponds to a switching portion of the present invention and includes a path switching portion 32 for selectively switching between the PCI-e I/F 21 and the USB 3.0 I/F 22. In the case of switching to the PCI-e I/F 21, the path switching portion 32 connects a PCI-e device side connecting portion 33 and a controller side connecting portion 31, and in the case of switching to the USB 3.0 I/F 22, the path switching portion 32 connects a USB 3.0 device side connecting portion 34 and the controller side connecting portion 31.

The PHY bus switch 3 includes the PCI-e device side connecting portion 33 for connecting the SSD 7 corresponding to the PCI-e I/F 21, the USB 3.0 device side connecting portion 34 for connecting the HDD 8 corresponding to the USB 3.0 I/F 22, and the controller side connecting portion 31 for connecting the PCI-e I/F 21 and the USB 3.0 I/F 22 via the shared wiring 4. Note that, the SSD 7 corresponds to a first device of the present invention, the PCI-e device side connecting portion 33 corresponds to a first device side connecting portion of the present invention, the HDD 8 corresponds to a second device of the present invention, and the USB 3.0 device side connecting portion 34 corresponds to a second device side connecting portion of the present invention.

The PCI-e device side connecting portion 33, the USB 3.0 device side connecting portion 34 and the controller side connecting portion 31 include a differential transmission portion (transmission portion TX+, TX−) and a differential reception portion (reception portion RX+, RX−), respectively. Additionally, the SSD 7 and the HDD 8 similarly include the differential transmission portion (transmission portion TX+, TX−) and the differential reception portion (reception portion RX+, RX−).

Since a so-called plug-and-play function is supported in the PCI-e and the USB 3.0, it is possible to automatically recognize when a corresponding device is connected thereto. In this example, the PCI-e device side connecting portion 33 and the USB 3.0 device side connecting portion 34 of the PHY bus switch 3 are configured to have slots, and the path switching portion 32 automatically recognizes when the slots are equipped with the SSD 7 and the HDD 8, respectively, then, notifies a signal communication portion 35 of connection of the devices.

For example, the path switching portion 32 alternately repeats connection with the PCI-e device side connecting portion 33 (state of FIG. 2) and connection with the USB 3.0 device side connecting portion 34 (state of FIG. 3) at a constant interval, and in the case where the path switching portion 32 detects connection of the SSD 7, notifies the signal communication portion 35 of the connection of the SSD 7. On receipt of the notification, the signal communication portion 35 transmits a connection signal indicting the connection of the SSD 7 to the signal communication portion 23 on the controller 2 side. Thereby, the controller 2 recognizes the connection of the SSD 7. Similarly, also for the HDD 8, the connection is able to be recognized.

Further, although it is basically similar for the case where the connection of the SSD 7 is cancelled, in this case, the path switching portion 32 detects connection cancellation of the SSD 7. Then, notification to the signal communication portion 35 is made that the connection of the SSD 7 is cancelled. The signal communication portion 35 on receipt of the notification transmits a cancel signal indicating the connection cancellation of the SSD 7 to the signal communication portion 23 on the controller 2 side. Thereby, the controller 2 is able to recognize the connection cancellation of the SSD 7. The connection cancellation is able to be recognized similarly for the HDD 8.

As described above, the controller 2 is able to recognize a connection status of whether or not the corresponding device is connected to each of the PCI-e device side connecting portion 33 and USB 3.0 device side connecting portion 34. Then, the signal communication portion 23 of the controller 2 corresponding to a switching signal output portion of the present invention outputs a switching signal for switching between the path of the PCI-e I/F 21 and the path of the USB 3.0 I/F 22. The signal communication portion 35 of the PHY bus switch 3 transmits, when receiving the switching signal from the signal communication portion 23, a command signal (High/Low) to the path switching portion 32 based on the received switching signal, and on receipt of the command signal, the path switching portion 32 switches between the path connecting the PCI-e I/F 21 and the SSD 7 and the path connecting the USB 3.0 I/F 22 and the HDD 8.

Specifically, when data (differential signal) is transmitted to the SSD 7 or the HDD 8, a device as a destination of the data (SSD 7 or HDD 8) is specified by operation of a user or the like. Further, when data is received from the SSD 7 or the HDD 8, similarly, a device as a source of data (SSD 7 or HDD 8) is specified by operation of a user or the like. The signal communication portion 23 on the controller 2 side then outputs a switching signal according to the serial communication I/F of the device specified in the above to the PHY bus switch 3.

For example, in the case of transmitting data to the SSD 7, as illustrated in FIG. 2, the signal communication portion 23 on the controller 2 side outputs a PCI-e switching signal to the PHY bus switch 3. The PHY bus switch 3 receives the PCI-e switching signal at the signal communication portion 35 and outputs “High” to the path switching portion 32 according to the received PCI-e switching signal. According to the “High” from the signal communication portion 35, the path switching portion 32 switches internal wiring of the PHY bus switch 3 so that the controller side connecting portion 31 and the PCI-e device side connecting portion 33 are connected to establish the path between the PCI-e I/F 21 and the SSD 7. Thereby, the data is able to be transmitted to the SSD 7 which is the PCI-e-compliant device.

Additionally, in the case of transmitting data to the HDD 8, as illustrated in FIG. 3, the signal communication portion 23 on the controller 2 side outputs a USB 3.0 switching signal to the PHY bus switch 3. The PHY bus switch 3 receives the USB 3.0 switching signal at the signal communication portion 35 and outputs “Low” to the path switching portion 32 according to the received USB 3.0 switching signal. According to the “Low” from the signal communication portion 35, the path switching portion 32 switches internal wiring of the PHY bus switch 3 so that the controller side connecting portion 31 and the USB 3.0 device side connecting portion 34 are connected to establish the path between the USB 3.0 I/F 22 and the HDD 8. Thereby, the data is able to be transmitted to the HDD 8 which is the USB 3.0-compliant device.

Further, although same basically applies to the case where data is received from the SSD 7 or the HDD 8, in the case where data is received from the SSD 7, as illustrated in FIG. 2, the signal communication portion 23 on the controller 2 side outputs a PCI-e switching signal to the PHY bus switch 3. The PHY bus switch 3 receives the PCI-e switching signal at the signal communication portion 35 and outputs “High” to the path switching portion 32 according to the received PCI-e switching signal. According to the “High” from the signal communication portion 35, the path switching portion 32 switches internal wiring of the PHY bus switch 3 so that the controller side connecting portion 31 and the PCI-e device side connecting portion 33 are connected to establish the path between the PCI-e I/F 21 and the SSD 7. Thereby, the data is able to be received from the SSD 7 which is the PCI-e-compliant device.

Further, in the case of receiving data from the HDD 8, as illustrated in FIG. 3, the signal communication portion 23 on the controller 2 side outputs a USB 3.0 switching signal to the PHY bus switch 3. The PHY bus switch 3 receives the USB 3.0 switching signal at the signal communication portion 35 and outputs “Low” according to the received USB 3.0 switching signal to the path switching portion 32. According to the “Low” from the signal communication portion 35, the path switching portion 32 switches internal wiring of the PHY bus switch 3 so that the controller side connecting portion 31 and the USB 3.0 device side connecting portion 34 are connected to establish the path between the USB 3.0 I/F 22 and the HDD 8. Thereby, the data is able to be received from the HDD 8 which is the USB 3.0-compliant device.

As described above, the controller 2 is able to output the switching signal to the PHY bus switch 3 according to operation by a user to switch a path of the path switching portion 32. Since the controller 2 is connected to the CPU 5 on the information processing apparatus side in FIG. 1, the CPU 5 detects when the user specifies a device from an operation portion (not illustrated), and control the controller 2. For example, when the user specifies the HDD 8, the CPU 5 instructs the controller 2 to output the USB 3.0 switching signal corresponding to the HDD 8.

Here, when the controller 2 receives data from the SSD 7 or the HDD 8, data is received by both the PCI-e I/F 21 and the USB 3.0 I/F 22, however, it is controlled that processing of data is performed by only the serial communication I/F corresponding to the received data, and a serial communication I/F not corresponding therewith ignores the data. For example, in the case where data of the PCI-e is received from the SSD 7, only the PCI-e I/F 21 recognizes data and performs subsequent processing, and the USB 3.0 I/F 22 ignores the data so that the subsequent processing is not to be performed. Whereas, when the data is a signal of the USB 3.0 from the HDD 8, only the USB 3.0 I/F 22 recognizes the data and performs subsequent processing, and the PCI-e I/F 21 ignores the data so that the subsequent processing is not to be performed.

As described above, description has been given for the embodiments of the interface device 1 and the information processing apparatus provided with the interface device 1, however, it is possible to mount the interface device 1 on a wiring board, and the present invention may be thus provided as a form of a wiring board having the interface device 1 mounted thereon. Specifically, it is possible to provide a form of the wiring board on which the controller 2 and the PHY bus switch 3 constituting the interface device 1 are mounted.

In this manner, according to the present invention, the PCI-e I/F and the USB 3.0 I/F have the restrictions of the impedance and the electric characteristic equivalent to each other so as to be able to share the board wiring therebetween. Thereby, it is possible to reduce redundant wiring, thus being capable of reducing a board area. Further, the PHY bus switch to selectively switch between the path of the PCI-e I/F and the path of the USB 3.0 I/F is provided, so that it is possible to flexibly address a design change or the like.

As described above, according to the present invention, in the case of mounting two serial communication interfaces such as PCI-e and USB 3.0 with standards different from each other, wiring for PCI-e and wiring for USB 3.0 are shared therebetween, and a switching portion is provided for selectively switching between the PCI-e and the USB 3.0, so that it is possible to flexibly address a design change or the like and reduce a board area.

1. An interface device comprising:
a first serial communication interface;
a second serial communication interface with characteristic impedance and an electric characteristic which are equivalent to those of the first serial communication interface; and
a controller provided with the first serial communication interface and the second serial communication interface, wherein
a switching portion is provided for selectively switching between the first serial communication interface and the second serial communication interface, and wiring for connecting the first serial communication interface and the switching portion and wiring for connecting the second serial communication interface and the switching portion are shared therebetween.

2. The interface device as defined in claim 1, wherein
the switching portion includes a first device side connecting portion for connecting a first device corresponding to the first serial communication interface; a second device side connecting portion for connecting a second device corresponding to the second serial communication interface; and a controller side connecting portion for connecting the first serial communication interface and the second serial communication interface via the shared wiring; and in the case of switching to the first serial communication interface, the first device side connecting portion and the controller side connecting portion are connected, and in the case of switching to the second serial communication interface, the second device side connecting portion and the controller side connecting portion are connected.

3. The interface device as defined in claim 1, wherein
the controller includes a switching signal output portion to output a switching signal for switching between the first serial communication interface and the second serial communication interface, and the switching portion switches between the first serial communication interface and the second serial communication interface based on the switching signal output from the switching signal output portion.

4. The interface device as defined in claim 1, wherein
the first serial communication interface is a PCI-Express system interface, and the second serial communication interface is a USB 3.0 system interface.

5. A wiring board having the interface device as defined in claim 1 mounted thereon.
